(19) United States
(12) Patent Application Publication
(10) Pub. No.: US 2006/0132431 A1
(43) Pub. Date: Jun. 22, 2006

(54) Multi-function digital device as a human-input-device for a computer

(76) Inventors: Oren Eytan Eliezer, Plano, TX (US); Carl M. Panasik, Garland, TX (US); John Leonard Wallberg, Richardson, TX (US); Robert Bogdan Staszewski, Garland, TX (US)

Correspondence Address: TEXAS INSTRUMENTS INCORPORATED, P O BOX 655474, M/S 3999, DALLAS, TX, 75265, US

(21) Appl. No.: 11/015,562

(22) Filed: Dec. 17, 2004

(51) Int. Cl. G09G 5/00

(52) U.S. Cl. 345/156

(57) ABSTRACT

System and method for interfacing with a digital computer using a multi-function device. A preferred embodiment comprises a multi-function device comprising a controller configured to process information and regulate operations of the multi-function device, a sensor coupled to the controller, the sensor configured to capture information in a movement of the multi-function device or a movement of an object applied to the multi-function device and to provide the information to the controller, wherein the information is used to determine movement information. The multi-function device further comprises a radio frequency circuit also coupled to the controller, the radio frequency circuit is configured to exchange information with other devices via a plurality of communications networks, wherein one of the other devices is a computer and the information shared is movement information from the multi-function device.

### TECHNICAL FIELD

The present invention relates generally to a system for digital computing, and more particularly to a system and method for interfacing with a digital computer using a multi-function digital device.

### BACKGROUND

In a typical presentation room in a business, commercial, or academic setting, a computer is used to display electronically a set of visual slides being discussed by the presenter. The presenter may have a need to control the progress of the visual slides, typically by using a mouse and/or a dedicated pointer device. The mouse and/or the dedicated pointer device can enable the presenter to advance or review the visual slides as needed as well as to highlight certain portions of the visual slides to place emphasis on a particular point. The use of a mouse can be advantageous since substantially all computers come with a mouse in one form or another, while a dedicated pointer device can provide a degree of mobility due to its wireless nature or the presence of an extended attachment cable between the dedicated pointer device and the computer.

Depending on the situation, the computer may already be located in the room where the presentation is being held or the presenter may use his own computer. In many cases, the presenter may wish to use his own computer to enable him the ability to make last minute changes to the presentation and to ensure that the presentation will operate properly. Additionally, for general use in a meeting or presentation, the presenter can make use of his own computer to take notes, retrieve information in real-time, and other common tasks that can be performed with the aid of a computer. Typically, all of these operations require the use of a mouse or some other pointer control device. As often is the case, in these types of scenarios, the presenter is away from their usual office, wherein there may be a dedicated mouse (or pointer control device) permanently connected to the computer via a docking station or a port replicator, and is therefore forced to use the computer's built-in substitute for the mouse. While functional, in most portable computers the built-in substitute typically compromises ease of use for convenience. Therefore, many presenters (and users of portable computers in general) carry a wireless or wired mouse with them, which they use when they are away from their usual office.

One disadvantage of the prior art is that with a typical laptop, the mouse that is provided on a portable computer is not very easy to use, nor are they comfortable. As an alternative, the presenter can make use of an external mouse (either wired or wireless) or a dedicated pointer device. However, this adds yet another device that must be carried by the presenter, in addition to his cellular telephone, personal digital assistant, pager, and so forth.

A second disadvantage of the prior art is that the use of an external mouse and/or a dedicated pointer device means that the presenter not only has to carry an additional device, but it is an additional device that the presenter must also maintain (e.g. ensure that the device's battery is charged and the device is operational).

### SUMMARY OF THE INVENTION

These and other problems are generally solved or circumvented, and technical advantages are generally achieved, by preferred embodiments of the present invention, which provides a multi-function digital device that can also operate as a general human-input-device for a computer.

In accordance with a preferred embodiment of the present invention, a multi-function device comprising a controller that is configured to process information and regulate operations of the multi-function device, a sensor coupled to the controller, the sensor is configured to capture information in a movement of the multi-function device or a movement of an object applied to the multifunction device and to provide the information to the controller, wherein the information is used to determine movement information is provided. The multi-function device further comprises a radio frequency circuit coupled to the controller, the radio frequency circuit being configured to exchange information with other devices via a plurality of communications networks, wherein one of the other devices is a computer and the information shared is the movement information of the multi-function device.

In accordance with another preferred embodiment of the present invention, a method for operating a multi-function device as a controller device is provided. The method comprises placing the multi-function device into a controller mode, detecting changes in position of the multi-function device or in an object being applied to the multi-function device, computing movement information from changes in position, and transmitting movement information to a computer.

In accordance with another preferred embodiment of the present invention, a display system comprising a computer that is configured to display information on a display screen and a multi-function device coupled wirelessly to the computer, the multi-function device is configured to control the display of the information is provided. The multi-function device comprises a controller that is configured to process information and regulate operations of the multi-function device, a sensor coupled to the controller, the radio frequency circuit is configured to capture information in a movement of the multi-function device or a movement of an object applied to the multi-function device and to provide the information to the controller, wherein the information is used to determine movement information, and a radio frequency circuit coupled to the controller, the radio frequency circuit is configured to exchange information with other devices via a plurality of communications networks, wherein one of the other devices is the computer and the information shared is movement information of the controller device.

An advantage of a preferred embodiment of the present invention is that providing a multi-function digital device reduces the total number of devices that a user must carry and maintain. This can reduce the probability of the user forgetting to carry a needed device or forgetting to properly maintain it.

A further advantage of a preferred embodiment of the present invention is that the addition of the human-input-device capability to a multi-function digital device may require no modifications to the existing hardware and relatively minor software modifications. Therefore, the human-input-device capability can be added at a small cost.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a presentation system;

FIG. 2 is a diagram of a user with an assortment of electronic devices;

FIGS. 3a and 3b are diagrams of a cellular telephone with a built-in camera, wherein the camera can enable the use of the cellular telephone as a controller device, according to a preferred embodiment of the present invention;

FIGS. 4a through 4c are diagrams of a cellular telephone with a built-in camera, wherein the camera is located at a different point on the cellular telephone, wherein the camera can enable the use of the cellular telephone as a controller device, according to a preferred embodiment of the present invention;

FIGS. 5a through 5c are diagrams of an image sensor used in a camera of a cellular telephone, wherein limited portions of the image sensor are used in order to reduce power consumption, according to a preferred embodiment of the present invention;

FIG. 6 is a diagram of a use of a cellular telephone as a controller device for a computer, according to a preferred embodiment of the present invention;

FIGS. 7a and 7b are diagrams of cellular telephones capable of operating as controller devices, according to a preferred embodiment of the present invention;

FIG. 8 is a diagram of a back view of a cellular telephone, wherein the cellular telephone features an optical motion detection unit, according to a preferred embodiment of the present invention;

FIG. 9 is a diagram of a view of a cellular telephone, wherein the cellular telephone features a pointer, according to a preferred embodiment of the present invention;

FIGS. 10a through 10c are diagrams of a multi-function device that can function as a controller device and the use of a touch sensitive screen from such a device, according to a preferred embodiment of the present invention;

FIGS. 11a and 11b are diagrams of the use of telemetry to detect movements in a multi-function device operating as a controller device, according to a preferred embodiment of the present invention;

FIG. 12 is a diagram of a multi-function device, wherein the multi-function device has the capability of operating as a controller device; and

FIG. 13 is a diagram of a sequence of events describing the operations of a cellular telephone when it is operating in a controller mode, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely the addition of the capability to function as a human-input-device for a computer system to a cellular telephone (or multi-function digital device) with no (or little) modification to the hardware of the cellular telephone. The invention may also be applied, however, to the addition of the capability to function as a human-input-device (as well as other functionality) to other multi-function digital devices, such as personal digital assistants (PDAs), combination devices (combination cellular telephone and PDA), pagers, and so forth, with no (or very little) modification to the hardware of the multi-function digital device.

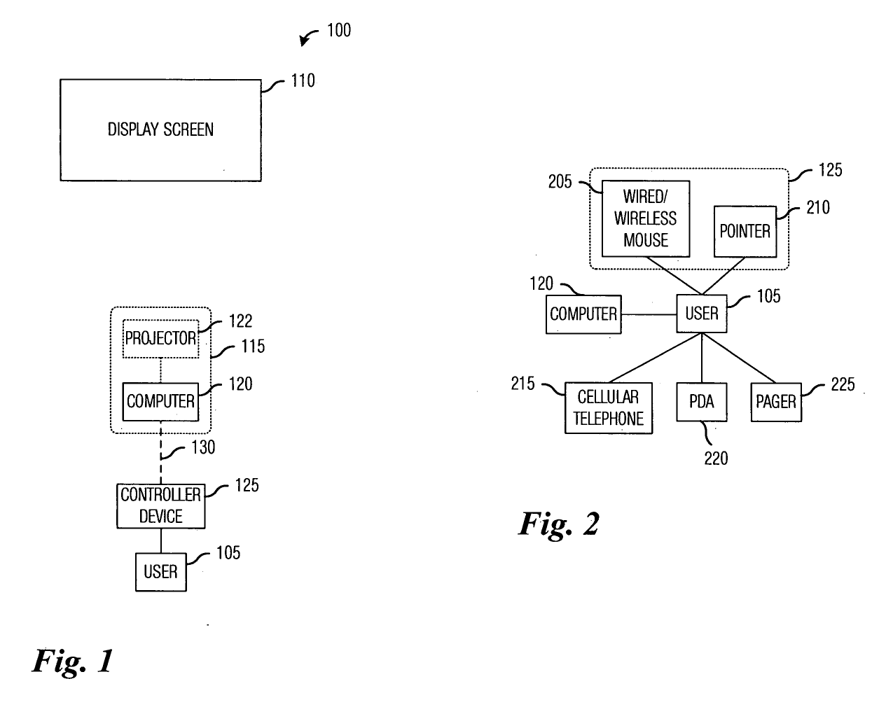

With reference now to FIG. 1, there is shown a diagram illustrating a presentation system 100 wherein a user 105 can display a presentation onto a display screen 110. The presentation system 100 allows the user 105 to display a presentation on a display screen 110 and potentially accompany the presentation with pre-recorded or live audio and vocal information. Note that the presentation system 100 can also be used as a large display system capable of replacing a typical computer display, such as a CRT or LCD display. Therefore, the presentation system 100 can be used to display normal computer screens, project videogame console images, and so forth. Therefore, the discussion of a presentation system should not be construed as being limiting to the present invention.

The presentation can be displayed on the display screen 110 through the use of a display system 115, which can include a computer 120 to generate the display and, depending upon the type of display screen 110, a projector 122. The projector 122 may be one of a wide variety of light projectors that can be used to project the presentation generated by the computer 120 onto the display screen 110. For example, the projector 122 may be a digital light processor (DLP) projector that is coupled to the computer 120 and can project images generated by the computer 120 onto the display screen 110. Alternatively, the display screen 110 may be an actual computer screen and the computer 120 can be coupled to the display screen 110 and the display screen 110 can be directly driven by the computer 120. When the computer 120 is directly driving the display screen 110, the projector 122 may not be present in the display system 115 or it may be present, but not used.

The user 105 can control the progression of the presentation by a controller device 125. Examples of the controller device 125 may be a mouse, a track ball, a dedicated pointer device, and so forth. The controller device 125 may be an integral part of the computer 120, such as a built-in mouse of a portable computer, or it can be an external device that can be coupled to the computer 120 via a connection 130. The connection 130 can be wired or wireless in nature. Through the controller device 125, the user 105 can move forward or backward through the presentation, highlight specific parts of the presentation by moving a cursor or pointer, initiate and control specially prepared multimedia portions of the presentation and so forth.

As discussed above, the controller device 125 may be an adaptation of a general purpose controller device, such as the computer's mouse or trackball, or the controller device 125 may be a specially designed device such as a dedicated pointer device. If the controller device 125 is an adaptation of a general purpose device, then it may not function in an ideal manner when it comes to controlling various aspects of the presentation. For example, the shape of the controller device 125 may not be comfortable for extended use, the operating range may not be as widespread as desired, some desired functionality may not be available, and so on. While, if the controller device 125 is a specially designed device, then the controller device 125 may be ideally suited to control the different aspects of the presentation. However, since the specially designed device is likely not to be an integrated part of the computer 120, it can require separate maintenance and/or it can get lost.

With reference now to FIG. 2, there is shown a diagram illustrating the user 105 with an exemplary assortment of electronic devices that can be carried by the user 105. In many instances, the user 105 making a presentation may wish to use their own personal computer to generate the presentation. The user 105 may wish to do so because they will be able to make last minute changes to the presentation, they are ensured that the presentation will display as they want it to display, and so forth. A disadvantage of such an arrangement can be that the user 105 may have a large number of electronic devices that must be carried around in addition to the computer 120. For example, a typical user may carry the computer 120 and the controller device 125, which may in turn include a wired/wireless mouse 205 and a pointer 210, as well as a cellular telephone 215, a personal digital assistant (PDA) 220, a pager 225, and so on. With such a large number of devices, the user 105 may not be able to ensure that all of the devices are in proper operating condition (such as fully charged batteries for all devices) and in some instances, some devices may be inadvertently forgotten or lost.

A fairly ubiquitous electronic device today is the cellular telephone, with a large percentage of the cellular telephones in use today having a camera built into the telephone to permit their users to take moderate quality snapshots. It can be possible to use the imaging system built into these cellular telephone to enable the use of the cellular telephone as a controller device that can be capable of substituting for a mouse or a pointer control device. In addition to communicating with the cellular network using GSM, CDMA, TDMA, and so forth, many cellular telephones (especially the ones featuring cameras) also feature short range wireless capability. In many cases, the short range wireless capability is provided by a Bluetooth compliant personal area network adapter. However, the cellular telephone may also support other forms of short range wireless communications adapters, such as those supporting IEEE 802.11 (Wi-Fi), IEEE 802.15.4a (low data-rate ultra-wideband), IEEE 802.15.3a (high data-rate ultra wideband), infrared, ultrasonic, and other proprietary and non-proprietary forms of wireless communications.

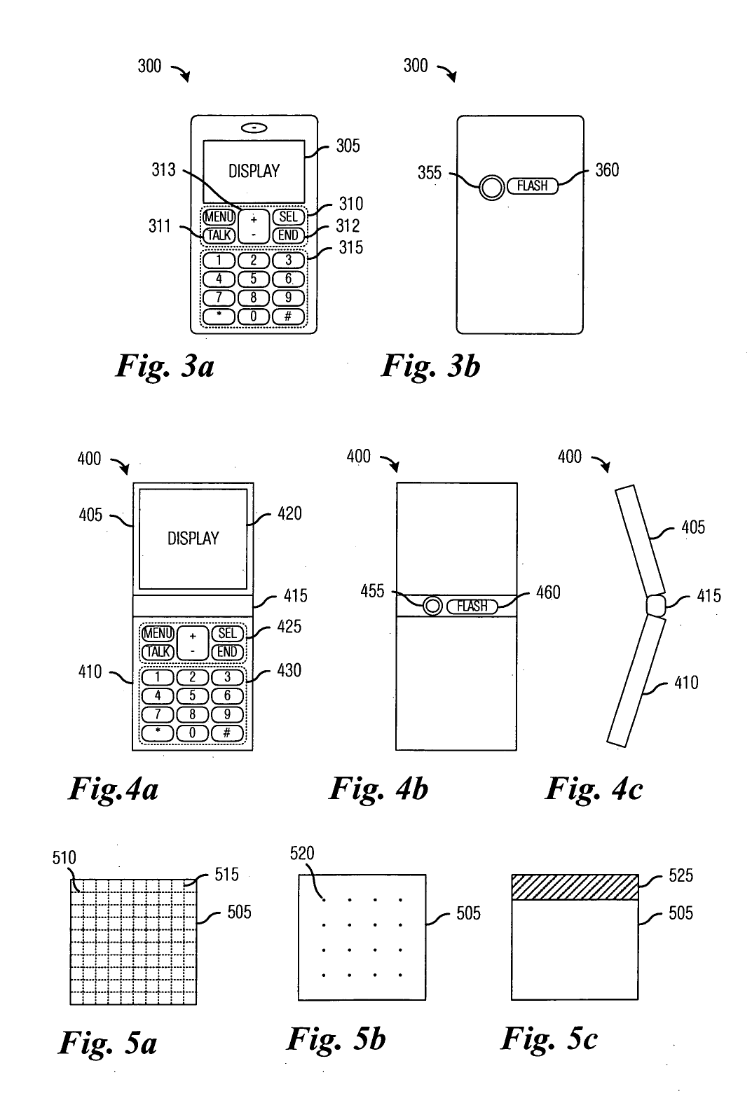

With reference now to FIGS. 3a and 3b, there are shown diagrams illustrating a cellular telephone 300 with a built-in camera that can enable the use of the cellular telephone as a controller device, according to a preferred embodiment of the present invention. The diagram shown in FIG. 3a illustrates a view of the front of the cellular telephone 300, showing a display 305, a set of control keys 310, and a set of numeric keys 315. In normal use, a user can enter a telephone number to dial using the set of numeric keys 315 and then initiate and end a call using some of the keys in the set of control keys 310 while the display 305 can provide visual information pertaining to the call.

When used as a controller device, some (or all) of the keys of the cellular telephone 300 can be used as buttons on the controller device. For example, if the cellular telephone 300 is to be used as a wireless mouse, then one of the keys of the cellular telephone 300, such as a ‘talk’ key 311, can be used to replicate a left click button of the wireless mouse, while an ‘end’ key 312 can be used to replicate a right click button of the wireless mouse and a ‘plus/minus’ key 313 can be used to replicate a scroll button. Note that depending upon implementation, different keys of the cellular telephone 300 can be used and the ones discussed above are only meant to be representative of the keys that can be used. When used as a controller device, the cellular telephone 300 may need to be placed into a special operating mode to help ensure that the actuation of the keys of the cellular telephone 300 will not result in a call being made erroneously.

However, if the cellular telephone 300 features speakerphone functionality or if a hands-free headset is used, the cellular telephone 300 may still permit a telephone conversation to be initiated, terminated, and/or held, since in such cases the cellular telephone 300 would not need to be held against the user's ear, which would have disrupted the use of the cellular telephone 300 as a controller device. If the use of the cellular telephone 300 as a telephone is permitted during operation as a controller device, then a special operating mode may be required, wherein at least some of the keys of the cellular telephone 300 can be used to initiate, terminate, or hold a call and therefore, cannot be used as part of the controller device. Alternatively, some of the keys of the cellular telephone 300, such as those in the set of control keys 310, may be reserved for use as standard telephone keys and only keys in the set of numeric keys 315 can be used as part of the controller device. Alternatively, appropriate software may enable the cellular telephone 300 to automatically modify the function of its keys and the contents of its display upon reception of an incoming call or upon user origination of a call.

In addition to replicating simple functions, such as the left and right click buttons, keys on the cellular telephone 300 can be programmed to perform desired functions. For example, one button can be programmed to initiate the presentation, another can be programmed to stop the presentation, another can be programmed to jump to a particular position in the presentation, yet another can be programmed to begin an audio and/or multimedia portion of the presentation, and so forth. The programming of the keys can be performed on the cellular telephone 300 itself or it can be performed on a computer and then downloaded onto the cellular telephone 300 either through a wired connection or a wireless communications link.

The display 305 can feature touch sensitivity. The display 305 can be able to detect the position of the user's finger to determine the actuation of a soft key as well as also being able to detect the movement of the user's finger across its surface. For example, the user can slide a finger across the display 305 to control the movement of a cursor being projected onto the presentation display in addition to tapping the display 305 to indicate the actuation of a button. This can be similar to a touch sensitive pad present on many portable computers, wherein the touch sensitive pad can detect the movement of the user's finger as well as its position. The movement of the user's finger can be used to move the portable computer's cursor while the position of the user's finger can be used to indicate an actuation of a mouse button.

The diagram shown in FIG. 3b illustrates a view of the back of the cellular telephone 300, showing a lens 355 and a flash 360. The lens 355 and the flash 360 can be part of an optical camera built into the cellular telephone 300, wherein the lens 355 can be an input for optical information while the flash 360 can assist the low-light imaging capabilities of the lens 355 by providing additional light. Note that the flash 360 may be an optional feature in certain cellular telephones and may not be present in every cellular telephone that has the capability of taking pictures. Additionally, while the lens 355 and the flash 360 are shown to be located on the back of the cellular telephone 300, the actual location can vary depending upon the manufacturer of the cellular telephone 300. For example, the lens 355 and the flash 360 may be located on an edge of the cellular telephone 300 or they may be located on an expansion module (not shown) that can be connected to a connector located on the cellular telephone 300 (in the majority of cases, the connector is located on the bottom of the cellular telephone 300).

With reference now to FIGS. 4a through 4c, there are shown diagrams illustrating a cellular telephone 400 with an alternate design for an optical camera that can also be used as a controller device, according to a preferred embodiment of the present invention. The cellular telephone 400 differs from the cellular telephone 300 (FIGS. 3a and 3b) in that the cellular telephone 400 comprises two portions, a display portion 405 and a keypad portion 410, that can be folded together. The display portion 405 and the keypad portion 410 can be connected via a hinge 415, the hinge 415 enabling the display portion 405 and the keypad portion 410 to be folded into a compact package. While the ability to fold can make the cellular telephone 400 more compact than the cellular telephone 300, both telephones feature a display (a display 420 (FIG. 4a)) and keys (keys 425 and 430 (FIG. 4a)). In many cases, the display 420 and the keys 425 and 430 can be made larger than on a cellular telephone that does not fold. The larger size of the display 420 and the keys 425 and 430 can enable easier operation, both as a telephone and as a controller device.

The diagram shown in FIG. 4b illustrates a view of the back of the cellular telephone 400. On folding cellular telephones that feature optical cameras, the camera is often placed on the hinge 415 of the cellular telephone 400. As in the cellular telephone 300 discussed above, the camera comprises a lens 455 and, in some cases, a flash 460. The diagram shown in FIG. 4c illustrates a side view of the cellular telephone 400 with the cellular telephone 400 in a partially closed state. Note however, that the camera can also be located at different locations on the cellular telephone 400 as well as on an expansion module as discussed previously.

Digital cameras typically use charge-coupled device (CCD) or complementary metal oxide semiconductor (CMOS) sensors (not shown) to convert optical information into electrical information. Movement of the cellular telephone (and hence the sensor) can be detected by the processing of consecutive images and using movements captured in the images to infer the magnitude and direction of the movement of the cellular telephone. In order to determine the distance between the camera and the objects captured by it, on which the calculation of the camera's movement may be based, an automatic distance measurement capability of the camera would be used (such as auto-focusing) or a manual gain setting feature (i.e. calibration) could be supported. With the manual gain setting, the user could adjust the setting in the cellular telephone so that movements of a specific magnitude could result in corresponding movements of the computer's pointer. The processing of images to determine movement is considered to be well known by those of ordinary skill in the art of digital image processing and of the present invention. Such processing techniques will not be discussed herein.

With reference now to FIGS. 5a through 5c, there are shown diagrams illustrating alternate uses of exemplary image sensors 505 used in a camera for a cellular telephone, wherein limited portions of the image sensors 505 are used to reduce power consumption, according to a preferred embodiment of the present invention. As discussed previously, a digital camera typically uses either CCD or CMOS sensors to convert optical information into electrical information that can be processed into images. If the image sensor 505 is turned on continually while the cellular telephone is being used as a controller device, the power consumption can be considerable and can dramatically shorten battery life for the cellular telephone. To help reduce power consumption, it may be possible to turn on the image sensor 505 only when needed rather than having the image sensor 505 powered on continuously. For example, if the cellular telephone is used as a controller device, it may be sufficient to have the image sensor 505 capture images several times a second, perhaps 10 to 15 times a second (or some other frequency that provides adequate performance). When the image sensor 505 is not being used to capture an image, the image sensor 505 may be powered down to reduce power consumption. In addition to powering down the image sensor 505, other parts of the cellular telephone 300 that are involved in the image process, such as a processor and memory, can also be powered down to further reduce power consumption.

Additionally, while the image sensor 505 may not provide the highest image quality, its resolution is more than required for use as an optical sensor when the cellular telephone is being used as a controller device. Therefore, image data from the entire image sensor 505 may not be needed to determine movement in the cellular telephone. Hence, image data from a portion or a part of the image sensor 505 rather than the entire image sensor 505 can be sufficient to determine movement. This can reduce power consumption since less time is spent retrieving and processing the image data, and potentially less circuitry is powered (for example, the unused portions of the image sensor 505 may not need to be powered). The diagrams shown in FIGS. 5a through 5c illustrate techniques that can be used to reduce power consumption.

The diagram shown in FIG. 5a illustrates the use of certain rows and columns of image sensors in the image sensor 505 to determine movement information. According to a preferred embodiment of the present invention, every N-th row 510 and M-th column 515 of the image sensor 505 can be turned on in order to detect image information, wherein N and M are integer numbers. It is preferred that N and M are power of two (2) numbers, although not required. For example, if every 8-th row and 8-th column are turned on (with remaining rows and columns turned off), the power consumption could be as low as 12.5 percent of the power consumed when the entire image sensor 505 is turned on.

The diagram shown in FIG. 5b illustrates the use of certain image sensors in the image sensor 505 to determine movement information. According to a preferred embodiment of the present invention, rather than using entire rows and columns of image sensors, certain individual image sensors (such as sensor 520) can be used. For example, every 256-th image sensor can be used to capture image information.

The diagram shown in FIG. 5c illustrates the use of a portion of the image sensor 505 to determine movement information. According to a preferred embodiment of the present invention, a region 525 (a portion) of the image sensor 505 can be used to capture image data for use in determining movement in the cellular telephone. The size and orientation of the regions may be dependent upon the arrangement of the light detection sensors in the image sensor 505. For example, if the image data is to be read off in row order format, then a region should be arranged along the rows of sensors and if the image data is to be read off in column order format, then a region should be arranged along the columns of sensors.

According to yet another preferred embodiment of the present invention, another way to reduce power consumption would be to only power up the rows 510 and 515, individual image sensors 520, or region 525 of the image sensor 505 that is being used and leaving the remainder of the image sensor 505 in an off state. For example, referencing the diagram shown in FIG. 5c, only the image sensors in the region 525 may be powered on while the image sensors in the remainder of the image sensor 505 may be left in the powered off state.

In its usual configuration, an optical camera may not be able to focus at the short distances needed to provide an in-focus image of the surface upon which the cellular telephone 300 is resting. An optical camera in a cellular telephone may be able to produce accurately focused images from objects that are as close as a few inches to objects that are very far away. However, the ability to focus within a few millimeters away from the image sensor 505 may not be available without some assistance. According to a preferred embodiment of the present invention, when the cellular telephone 300 is to be used as a controller device, the cellular telephone 300 is to be placed into a special operating mode. When placed into this special operating mode, the cellular telephone 300 can automatically move a special lens into position in front of the image sensor 505 to afford it the capability to clearly focus a few millimeters in front of the image sensor 505. Alternatively, the cellular telephone 300 can decrease the minimum focusing distance of the image sensor 505 by bringing a lens that is already in front of the image sensor 505 closer to the image sensor 505. By moving the lens closer to the image sensor 505, the focal distance of the lens is reduced.

According to yet another preferred embodiment of the present invention, the user of the cellular telephone 300 may manually move a lens into position after setting the cellular telephone 300 into the special operating mode. This can be done by manually actuating a sliding button that pushes a lens into a proper position. Alternatively, the user may place an optical adapter over the existing lens over the image sensor 505, wherein the purpose of the optical adapter is to permit the image sensor 505 to accurately focus at short distances.

According to yet another preferred embodiment of the present invention, a digital image processing algorithm may be used to process the unfocused images sufficiently to recover the movement information, thereby eliminating the need for physical changes in the camera's optics.

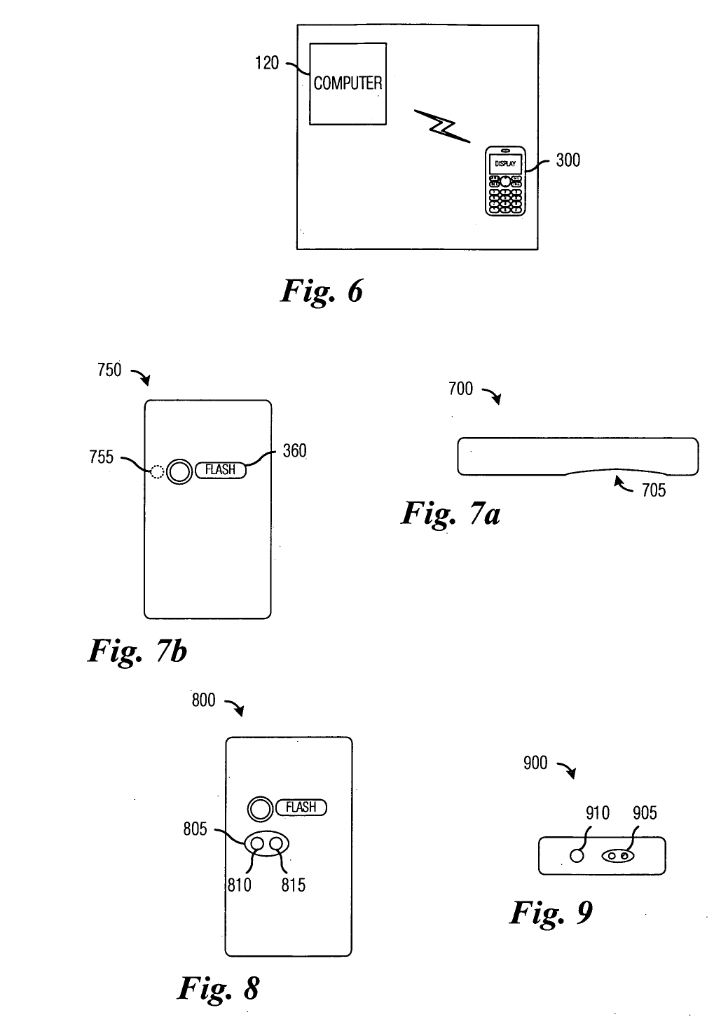

With reference now to FIG. 6, there is shown a diagram illustrating the use of the cellular telephone 300 as a controller device for the computer 120, according to a preferred embodiment of the present invention. As discussed previously, the use of a camera in conjunction with some additional data processing in software, can make it possible to use the cellular telephone as a controller device for the computer 120. For example, the cellular telephone 300 can be used as a mouse, permitting the user 105 the ability to perform any operation that could be performed by a normal mouse. The cellular telephone 300 can also be used as a replacement for a dedicated controller device used in presentations to provide the user 105 the ability to control the progress of the presentation.

According to a preferred embodiment of the present invention, the cellular telephone 300 can communicate with the computer 120 via a short range wireless connection, such as one using Bluetooth, IEEE 802.11, IEEE 802.15.3a, IEEE 802.15.4a, infrared, ultrasonic, or any other proprietary or non-proprietary forms of wireless communications. Alternatively, a wired connection can be made between the cellular telephone 300 to the computer 120. For example, a connection can be made to an edge connector (not shown) that is typically present on the bottom of the cellular telephone 300 to a serial port, a parallel port, a USB port, a Firewire port, and so on at the computer 120.

The cellular telephone 300 can then make use of the short range wireless connection to provide connectivity to the computer 120 to provide an exchange of information related to the use of the cellular telephone 300 as a controller device, while at the same time, it can be possible for the cellular telephone 300 to make use of a cellular network, such as a GSM, CDMA, TDMA, and so forth, to provide a voice and/or data connection. For example, in a cellular telephone with a speakerphone capability, it can be possible for the user 105 to hold a conversation at the same time a presentation is being made. This can be conducive in holding a teleconferencing meeting, wherein video and/or audio from the presentation can be provided to a remotely located person or party.

It can also be possible to combine the short range wireless connection between the cellular telephone 300 and the computer 120 with the voice and/or data connection using a cellular type of network. The 4G (4^{th}-Generation) wireless networks, such as proposed in IEEE 802.16 or WiMax, which are medium range wireless networks and sometimes are referred to as wireless metropolitan area networks (WMAN), can be used to provide both types of connectivity. The 4G wireless network can provide data transfer capability together with voice capability when making use of technology such as voice-over-IP (VoIP). When using an appropriately configured cellular telephone, which can have the capability of making use of a wide variety of wireless networks (including cellular, WLAN, short range data, 4G, and so forth), as a controller device, the 4G or WLAN connection can be used to exchange information related to the use of the cellular telephone as a controller device with a computer being used to drive the presentation which is serviced by the same infrastructure. The cellular telephone can also make use of the 4G or WLAN wireless connection to provide a voice connection using the connection's VoIP capabilities. An advantage of using the VoIP capability of the 4G wireless connection rather than the cellular telephone's cellular connection can be that the use of VoIP makes use of existing bandwidth and does not incur the airtime charges typically associated with the use of a cellular network.

With reference now to FIGS. 7a and 7b, there are shown diagrams illustrating views of exemplary cellular telephones capable of operating as controller devices, according to a preferred embodiment of the present invention. When a cellular telephone (such as the cellular telephone 300) is being used as a controller device, for example, a mouse, the image sensor 505 requires an adequate level of light in order to capture image data that can be converted into movement information. If there is inadequate light, then the image sensor 505 may not be able to provide sufficient image data and image processing algorithms used to determine movement in the cellular telephone 300 and may not be able to determine if the cellular telephone is moving or the image processing algorithms may incorrectly determine movement in the cellular telephone 300.

The diagram shown in FIG. 7a illustrates a concave region 705 on the backside of a cellular telephone 700. The concave region 705 can let a sufficient amount of light reach the surface upon which the cellular telephone 700 is resting to enable adequate image data to be captured by the image sensor 505. The lack of material in the concave region 705 can permit ambient light to reach the surface upon which the cellular telephone 700 is resting as well as an image sensor in the cellular telephone 700.

Note that the performance of the cellular telephone 700 may be further enhanced if the cellular telephone 700 is being used on a surface that is specifically designed to improve performance. Certain surfaces, such as smooth and transparent surfaces, are not conducive to the use of optical mice. Note however, that a transparent surface, such as a glass table, can be advantageous to the present invention since it can allow the image sensor 505 to focus on objects that are further away (e.g., images that are below the surface of the table). According to a preferred embodiment of the present invention, the cellular telephone 700 can store an image file that can be printed onto a piece of paper and then the printed image can be used as a surface upon which the cellular telephone 700 can ride upon, simulating a mouse pad. The image file can have a special pattern that has been designed to improve movement detection in the presence of low light and focusing difficulties. For example, if the need should arise, the user 105 can print the image file, either directly from the cellular telephone 700 or by downloading it to the computer 120 and then printing it from the computer 120.

Note that if the image sensor 505 is located at a different place, such as the hinge 415 (FIG. 4b) of the cellular telephone 400, then it is not necessary to have the concave region 705 or to store an image file that can help optimize the operation of the image processing algorithms. Since the image sensor 505 of the cellular telephone 400 is not impeded by a surface upon which the cellular telephone 400 is resting, there should be sufficient light to gather adequate image data. Furthermore, since the image sensor 505 is no longer adjacent to the image upon which it is attempting to focus, there are no longer focusing difficulties.

Rather than having the concave region 705 on the back of the cellular telephone 700 to help increase the amount of ambient light received by the image sensor 505, the cellular telephone 700 may have its own light source. The diagram shown in FIG. 7b illustrates the use of the flash 360 to provide needed light. In many cellular telephone applications, the flash 360 is a high-intensity light emitting diode (LED) rather than a flash bulb that is used in a dedicated camera. The use of an LED as the flash 360 can permit the use of the flash 360 as an auxiliary light source. The flash 360 can be turned on only when illumination is needed and with a properly controlled intensity and duty cycle, power consumption can be minimized. Note that it may not be necessary to turn the flash 360 on at full power. Rather, it can be possible to turn the flash 360 on at partial power, to help reduce power consumption and to help reduce distractions due to the overly bright light.

However, if the flash 360 is an actual flash bulb, then a light emitting diode (LED) 755 located on a cellular telephone 750 can be used to provide needed light. According to a preferred embodiment of the present invention, the LED 755 may produce light in the visible light spectrum (such as white, blue, yellow, red, and so forth LEDs) or the LED 755 may produce light that is not visible to the human eye (such as infrared or near infrared LEDs). Note that if the flash 360 can be used as the auxiliary light source while the cellular telephone 300 is operating as a controller device, then it may not be necessary to also include the LED 755 on the cellular phone 750. An advantage of using an LED that produces invisible light is that there will be no light from the LED 755 to distract the audience of the presentation. However, to improve the battery life of the cellular telephone 750, it may be preferred to use an LED that is most efficient, e.g., an LED that produces sufficient light with minimum power consumption, be it a visible light LED or an invisible light LED. According to yet another preferred embodiment of the present invention, power consumption can be further reduced by powering the LED 755 only when the image sensor 505 is itself powered on. Furthermore, if the cellular telephone 750 is not in motion for an extended amount of time, then the LED 755 may be powered off completely.

With reference now to FIG. 8, there is shown a diagram illustrating a back view of a cellular telephone 800, wherein the cellular telephone 800 features an optical motion detection unit 805, according to a preferred embodiment of the present invention. The hardware to enable the detection of motion using optical methods can be relatively simple, a light source (if needed) and a light detector. It may then be possible to integrate an optical motion detection unit into a cellular telephone. The use of a dedicated optical motion detection unit 805 can have an advantage in that there is no need to further complicate the design of the lens used in the digital camera to support the need to be able to focus on objects that are extremely close to the lens. Such a mechanism can be readily adapted from optical mice and can be incorporated at little additional expense. The cellular telephone 800 includes the optical motion detection unit 805, which comprises a light detector 810 and a light source 815. Note that if sufficient ambient light is available, perhaps through the use of a concave region such as shown in FIG. 7a, the light source 815 may not be required. Once again, the light source may be an LED, producing either visible or invisible light, such as described previously in FIG. 7b.

With reference now to FIG. 9, there is shown a diagram illustrating a view of a cellular telephone 900, wherein the cellular telephone 900 features a pointer, according to a preferred embodiment of the present invention. When giving a presentation, the user often encounters a situation wherein he/she must highlight a certain portion of the presentation to place emphasis on a point or to respond to a question. The pointer, usually a laser pointer, can help the user do so. The cellular telephone 900 includes a digital camera 905 (comprising a flash and a lens/image sensor combination) and a laser pointer 910. A laser diode can be used to implement the laser pointer 910. In addition to use as a pointer, the laser diode 910 can also be used to help provide additional illumination for the image sensor 505 in situations wherein there is insufficient light.

Alternatively, the cellular telephone 900 can make use of the wireless mouse functionality for the purpose of controlling a pointer. This can be achieved whenever the material being presented is being provided by a computer that is also being controlled by the cellular telephone 900 operating as a wireless mouse. The computer can generate a pointer directly onto the display screen 110 and movements of the cellular telephone 900 can be detected and used to move the pointer on the display screen 110. The use of the cellular telephone 900 to move the pointer can be activated (or deactivated) with the actuation of a key (or a series of keys), permitting a toggling between the use of the cellular telephone 900 to control the location of the pointer and the progression of the presentation. Alternatively, the two functionalities may be supported simultaneously.

A current trend is to integrate more functionality into a single device. For example, there are many multi-function devices that can incorporate more than one of the following: a cellular telephone, a personal digital assistant (PDA), a pager, a multi-media player, a video camera, a digital camera, a video game machine, and so forth. These multi-function devices will typically have a larger display than that present on a simple cellular telephone and will, in general, have more computing power. Therefore, it is easier to add to such devices the controller functionally of the present invention.

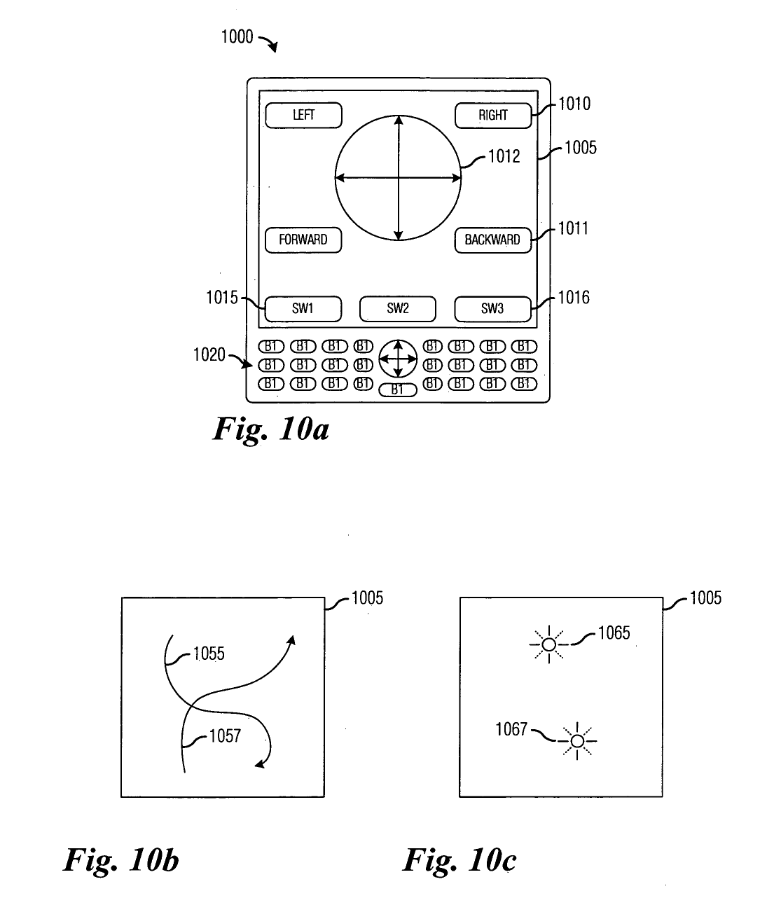

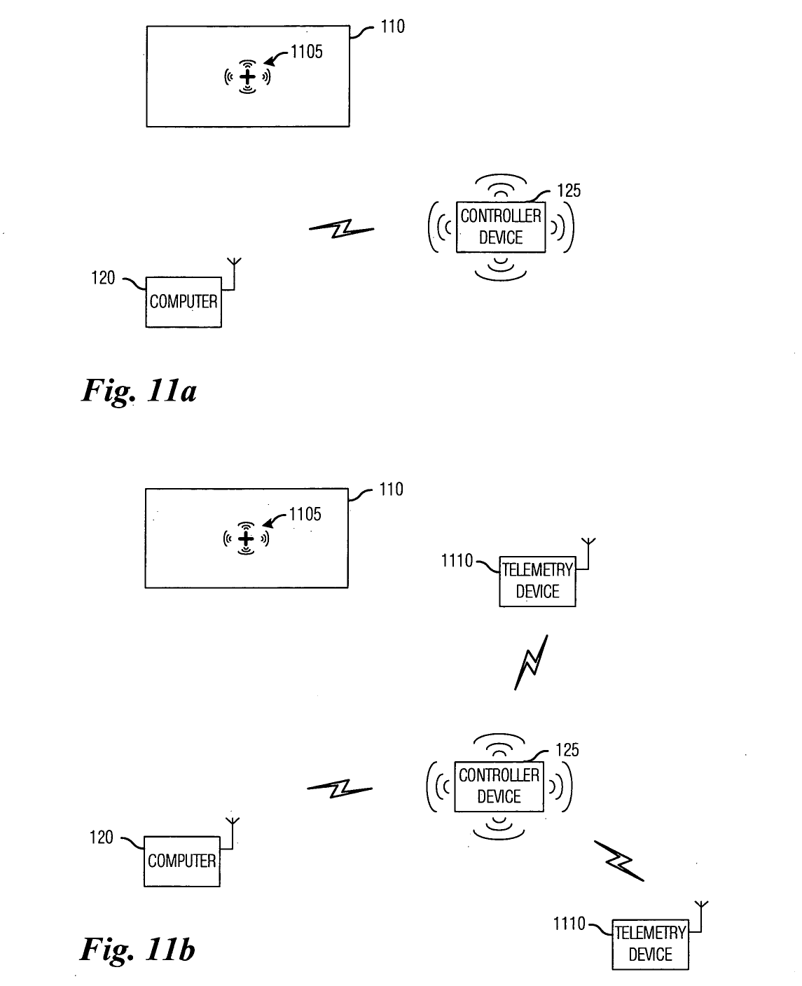

With reference now to FIG. 10a, there is shown a diagram illustrating a multi-function device 1000 that can function as a controller device, according to a preferred embodiment of the present invention. The multi-function device 1000 may include a large display 1005, which can include touch operation capability. When the multi-function device 1000 is operating as a controller device, the display 1005 can be used to assist the user in showing the presentation. The display 1005 can have programmable soft keys, such as presentation progression keys 1010, 1011, and 1012 or special function keys 1015 and 1016, in addition to the physical keys of the keypad 1020 of the multi-function device 1000. An advantage of using soft keys over physical keys is that the soft keys can be programmed to be of arbitrary size, notation (e.g. “start”, “play jingle”) and/or shape, only limited by the size of the display 1005. For example, soft keys 1010 and 1011 can be used to advance through portions of the presentation while soft key 1012 can be used to move a cursor that can be used to highlight different parts of the presentation. Since the soft key 1012 can be used to move the cursor, it can be made larger to simplify its use and be shaped specifically to indicate its function. Similarly, the soft keys 1015 and 1016 can be programmed to perform certain tasks, such as automatic switching to desired portions of the presentation, initiating a video and/or audio clip, and so forth. The soft keys can be pre-programmed or the user can program certain soft keys to assist in his/her presentation.

In addition to the display 1005 being able to detect the position of the user's finger to determine the actuation of a soft key, the display 1005 may also be able to detect the movement of the user's finger across its surface. For example, the user can slide a finger across the display 1005 to control the movement of a cursor being projected onto the presentation display 110.

With reference now to FIGS. 10b and 10c, there are shown diagrams illustrating the use of the display 1005 to capture motion made by a user of the multi-function device 1000 to control the operation of a presentation system, according to a preferred embodiment of the present invention. As discussed previously, the display 1005, being a touch sensitive display, can detect the movement of an object on its surface. The object can be the user's finger(s) and or a stylus, pen, pencil, and so forth. Movement of the object (finger, stylus, pen, etc.) can be detected by the display 1005 (functioning as a sensor) and then subsequently translated into movement information that can result in a corresponding movement in a cursor.

The diagram in FIG. 10b illustrates several traces 1055 and 1057 that can be illustrative of movements made by an object on the surface of the display 1005. These movements can be captured by the display 1005 and can result in similar movements of a cursor being displayed on the display screen 110. The use of software in the multi-function device 1000 can add additional capabilities to the types of motion that can be detected by the display 1005. For example, a contact made to the display 1005 with a relatively short duration can be determined to be analogous to the actuation of a button on a mouse, while two short duration contacts can be analogous to a double-click of the mouse button. Alternatively, a contact with an extended duration may be determined to have the intent of moving the cursor. The diagram in FIG. 10c illustrates several short duration contacts 1065 and 1067 made on the surface of the display 1005.

Another mechanism that can be used to detect the device's movement and to translate that movement to a corresponding movement in a cursor can involve the use of telemetry. Rather than using image process techniques to detect movement in a device and then translating the movement to a corresponding movement in a cursor, telemetry using radio frequency signals and/or audio frequency signals can be used to determine movements in the device. An advantage of using telemetry with radio and/or audio/ultrasonic frequency signals is that it does not require the presence of an image sensor in the device and can operate in total darkness without the need to provide illumination.

With reference now to FIGS. 11a and 11b, there are shown diagrams illustrating the use of telemetry to detect movements in the controller device 125, allowing the controller device 125 to control a cursor 1105, according to a preferred embodiment of the present invention. The diagram shown in FIG. 11a illustrates the controller device 125 communicating with the computer 120 via a short range wireless connection, such as a Bluetooth connection, an IEEE 802.11 connection, a low-data rate IEEE 802.15.4a connection, a high-data rate IEEE 802.15.3a connection, or some other proprietary or non-proprietary form of wireless communications, and that motion in the controller device 125 is detected by either the controller device 125 or the computer 120 and the cursor 1105 is moved according to the motion in the controller device 125. It may be possible to use techniques such as signal strength measurements and/or ranging techniques to determine movement of the controller device 125 in relation to the computer 120. For example, the computer 120 and the controller device 125 can exchange messages to determine separation between the two. By maintaining the separation information, it can be possible to detect movements in the controller device 125.

The diagram shown in FIG. 11b illustrates an alternative embodiment for detecting motion in the controller device 125. Multiple telemetry devices 1110 can be used to help readily and accurately determine the position of the controller device 125 and the position information of the controller device 125 can be used to determine movements of the controller device 125. According to a preferred embodiment of the present invention, the telemetry devices 1110 can exchange information with the computer 120 and the computer 120 can perform any necessary computations to determine the position of the controller device 125 as well as the movement (if any) of the controller device 125.

In addition to using telemetry techniques, the cellular telephone 300 can make use of positional services, such as the Global Positioning System (GPS), to determine location changes and movement information. According to mandates by the Federal Communications Commission, newer cellular telephones must feature the ability to relay positional information to emergency services and many cellular telephone manufacturers are electing to embed GPS receivers in their products. According to a preferred embodiment of the present invention, the cellular telephone can provide positional information to the computer 120 and the computer 120 can then detect any movement in the cellular telephone 300. Alternatively, the cellular telephone 300 can detect its own movement using positional information derived from the positional service and provide movement information to the computer 120.

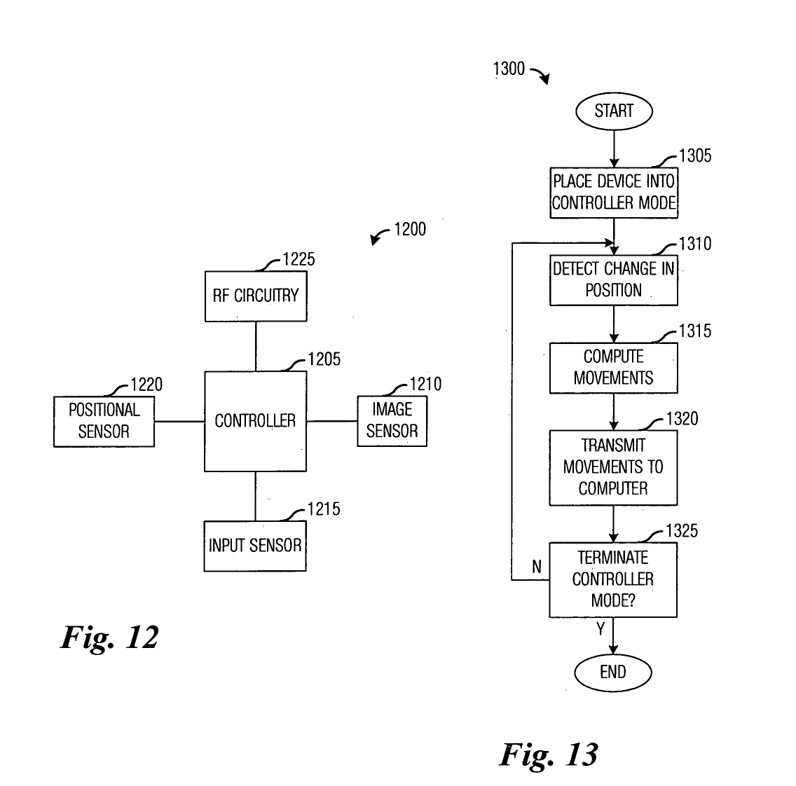

With reference now to FIG. 12, there is shown a diagram illustrating a view of a multi-function device 1200, wherein the multi-function device 1200 has the capability of operating as a controller device, according to a preferred embodiment of the present invention. The multi-function device 1200 may be a cellular telephone, a PDA, a pager, a multi-media player, a video game machine, or combinations thereof. The multi-function device 1200 can be controlled by a controller 1205, which can be responsible for executing programs that determine the operation of the multi-function device 1200. The controller 1205 may also be responsible for processing of information and data, both after they are received and prior to their transmission. An image sensor 1210, coupled to the controller 1205, can provide image data when the multi-function device 1200 is functioning as a digital camera or a controller device relying on image sensor data to determine movements of the multi-function device 1200.

The multi-function device 1200 may also include an input sensor 1215 (also coupled to the controller 1205) that can be used to detect user inputs, such as key presses and/or touches to a touch screen display (neither shown). The input detected by the input sensor 1215 can be provided to the controller 1205 where the input can be processed and appropriate action can be taken. If the multi-function device 1200 features location tracking technology, then a positional sensor 1220 can be a part of the multi-function device 1200. The positional sensor 1220 can receive transmissions from telemetry devices, such as GPS satellites and/or localized telemetry transmitters. The positional sensor 1220 can then provide the transmissions to the controller 1205 and the controller 1205 can decode the received transmissions to determine the position of the multi-function device 1200. As discussed previously, the position information of the multi-function device 1200 can be used to determine movements of the multi-function device 1200. Also coupled to the controller 1205 is RF circuitry 1225. The RF circuitry 1225 is responsible for receiving and transmitting information to and from the multi-function device 1200. For example, the multi-function device 1200 can make use of the RF circuitry 1225 to facilitate voice and data communications with other devices using long range cellular based communications networks and voice and data communications with other devices using short range wireless communications networks (including voice commands using an existing microphone of the wireless device).

With reference now to FIG. 13, there is shown a flow diagram illustrating a sequence of events 1300 describing the operations of a cellular telephone operating in a controller mode, according to a preferred embodiment of the present invention. As discussed previously, the user of the cellular telephone 300 can place the cellular telephone 300 into a controller mode by entering a command or a sequence of key strokes. The sequence of events 1300 describes operations made by the cellular telephone 300 after it executes the command (or the sequence of key strokes). According to a preferred embodiment of the present invention, the sequence of events 1300 describes operations that can execute on a CPU, DSP, controller, a specially designed integrated circuit, or so forth, that may also be responsible for controlling the operation of the cellular telephone 300. Note that although the sequence of events 1300 describes the operations as taking place in the cellular telephone 300, the sequence of events 1300 can also take place in a multi-function device that is capable of operation as a controller device.

After the cellular telephone 300 executes the command or receives the sequence of keystrokes that is designed to place the cellular telephone 300 into the controller mode, the controller places the cellular telephone 300 into the controller mode (block 1305), wherein the cellular telephone 300 can be used as a controller device. Once in the controller mode, the cellular telephone 300 periodically (or continually) monitors any changes in its position (block 1310). As discussed above, the cellular telephone 300 can monitor changes in its position by using an image sensor that is a part of a digital camera to capture image information, or it can use telemetry information provided by processing telemetry signals of wireless signals or via positional systems to compute any changes in its position. If the cellular telephone 300 is using its image sensor to detect changes in its position, it may be necessary at this point to make adjustments to its imaging system to afford it the ability to focus at short distances, such as moving its lens closer to the image sensor, placing an additional lens in front of the image sensor, or requiring the user to place an adapter in front of the image sensor.

Based upon the positional information, the controller computes movement information (block 1315). The controller can use an implementation of a movement detection algorithm to compute movement information from the positional information. The controller can then transmit the movement information to a computer that can be wirelessly coupled to the cellular telephone 300 (block 1320), wherein the cellular telephone 300 is operating as a controller device for the computer. As an alternative to having the controller compute the movement information from the positional information, the cellular telephone can transmit the positional information to the computer and the computer can perform the manipulation of the positional information, converting the positional information into movement information. The controller can also check to determine if the user wishes to terminate the operation of the cellular telephone 300 in controller mode (block 1325). If the user wishes to terminate the operation of the cellular telephone 300 in the controller mode, then the sequence of events 1300 is complete, otherwise the controller can return to detecting changes in position of the cellular telephone 300. Alternatively, the operation of the cellular telephone 300 in the controller mode may be controlled by a timer, wherein if the timer expires, the operation of the cellular telephone 300 in the controller mode terminates. The timer can be based upon an idle time of the cellular telephone 300, wherein if the cellular telephone 300 has been idle for a specified period of time, then the controller mode terminates. The timer can also be based upon a fixed period of time, wherein the cellular telephone 300 can only operate in the controller mode for the fixed period of time and when the period expires, the controller mode terminates.

In addition to detecting changes in position of the cellular telephone 300, the controller can also detect depressions of keys on a keypad of the cellular telephone 300 or on a touch-screen of the cellular telephone 300 or device 1000. Upon the detection of a key, the controller can execute an operation associated with the key, such as a mouse button click, execute a particular program provided by the user, jump to a certain portion of a presentation, begin (or stop) a multi-media clip, and so on. Many techniques exist for the detection of key presses, many of which are considered to be well understood by those of ordinary skill in the art of the present invention and will not be discussed herein.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A multi-function device comprising:
a controller configured to process information and regulate operations of the multi-function device;
a sensor coupled to the controller, the sensor configured to capture information in a movement of the multi-function device or a movement of an object applied to the multi-function device and to provide the information to the controller, wherein the information is used to determine movement information; and
a radio frequency circuit coupled to the controller, the radio frequency circuit configured to exchange information with other devices via a plurality of communications networks, wherein one of the other devices is a computer and the information shared is the movement information.

2. The multi-function device of claim 1, wherein the sensor comprises a positional sensor coupled to the controller, the positional sensor configured to receive transmissions from telemetry devices and to provide telemetry information to the controller.

3. The multi-function device of claim 1, wherein the sensor comprises an image sensor configured to capture optical information and to provide the optical information to the controller, wherein the optical information is used to determine movement information of the multi-function device.

4. The multi-function device of claim 3 further comprising a light source to provide light to help improve the quality of optical information captured by the image sensor.

5. The multi-function device of claim 4, wherein the image sensor periodically captures optical information, and wherein the light source is powered on only when the image sensor is capturing optical information.

6. The multi-function device of claim 3, wherein the sensor further comprises an input sensor configured to capture user input and to provide the user input to the controller.

7. The multi-function device of claim 1, wherein the sensor comprises a touch screen display configured to capture movement of the object applied to the touch screen display.

8. The multi-function device of claim 1, wherein the multi-function device is a cellular telephone with a built-in digital camera.

9. The multi-function device of claim 1, wherein a single wireless network is used to share information between the multi-function device and the computer as well as providing a voice or data connection with a remotely located user, network or database.

10. A method for operating a multi-function device as a controller device, the method comprising:
placing the multi-function device into a controller mode;
detecting changes in position of the multi-function device or in an object being applied to the multi-function device;
computing movement information from changes in position; and
transmitting movement information to a computer.

11. The method of claim 10, wherein the placing is initiated by a command or a sequence of key strokes.

12. The method of claim 10, wherein the detecting comprises:
capturing a sequence of images, wherein the capturing is performed by an image sensor; and
processing the sequence of images to detect a change in position.

13. The method of claim 10, wherein the detecting comprises:
sequentially capturing the state of sensors in a touch screen; and
processing the sequence of sensor states to detect a change in position.

14. The method of claim 10, wherein the movement information is transmitted over a short range wireless communications network.

15. The method of claim 10, wherein a voice connection can be held with a remotely located user, and a single wireless network provides both the transmission of the movement information and the voice connection.

16. The method of claim 10, wherein a data connection can be held with a remotely located user, network or database, and a single wireless network provides both the transmission of the movement information and the data connection.

17. A display system comprising:
a computer configured to display information on a display screen;
a multi-function device coupled wirelessly to the computer, the multi-function device configured to control the display of the information, the controller device comprising
a controller configured to process information and regulate operation of the controller device;
a sensor coupled to the controller, the sensor configured to capture information in a movement of the multi-function device or a movement of an object applied to the multi-function device and to provide the information to the controller, wherein the information is used to determine movement information; and
a radio frequency circuit coupled to the controller, the radio frequency circuit configured to exchange information with other devices via a plurality of communications networks, wherein one of the other devices is the computer and the information shared is movement information of the controller device.

18. The display system of claim 17, wherein the sensor comprises a positional sensor coupled to the controller, the positional sensor configured to receive transmissions from telemetry devices and to provide telemetry information to the controller.

19. The display system of claim 17, wherein the sensor comprises an image sensor configured to capture optical information and to provide the optical information to the controller, wherein the optical information is used to determine movement information of the multi-function device.

20. The display system of claim 17, wherein the sensor comprises a touch screen display configured to capture movement of the object applied to the touch screen display.
